(19) United States
(12) Patent Application Publication
(10) Pub. No.: US 2010/0241272 A1
(43) Pub. Date: Sep. 23, 2010

(54) Automated product transporting and sorting apparatus and method

(75) Inventors: Ralph Grimse, Hampton, NH (US); Mehmet Oktay Kaya, Exeter, NH (US); Heiner Luxem, Durham, NH (US); Rolando Antezana, Newmarket, NH (US); Chris Cote, Newmarket, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/587,529

(22) Filed: Oct. 8, 2009

Related U.S. Application Data
(60) Provisional application No. 61/210,595, filed on Mar. 20, 2009.

(51) Int. Cl. G06F 7/00; B07C 5/34

(52) U.S. Cl. 700/224; 700/223; 209/584

(57) ABSTRACT

An automated mail transporting and sorting apparatus is provided. The automated mail transporting and sorting apparatus includes an identifying and processing machine for determining a particular category from a group of at least two categories of each mail item of a continuous stream of mail items, the at least two categories including a first category and a second category; a first sorting machine for receiving mail items of the first category; a second sorting machine for receiving mail items of the second category; and a continuous gripper line including a plurality of grippers, each gripper being adapted to grip one of the mail items processed by the identifying and processing machine, the gripper line arranged and configured to transport mail items of the first category to the first sorting machine and mail items of the second category to the second sorting machine. A method of transporting and sorting mail items and a gripper apparatus are also provided.

Priority is claimed to U.S. Provisional Application No. 61/210,595, filed Mar. 20, 2009, the entire disclosure of which is incorporated by reference herein.

The present invention relates generally to an automated product transporting and sorting system and method and more specifically to an automated letter transporting and sorting system and method.

### BACKGROUND

U.S. Pat. No. 6,671,577 discloses a system and method for directly connecting an Advanced Facer Canceller System (“AFCS”) to a Delivery Bar Code Sorter (“DBCS”).

### SUMMARY OF THE INVENTION

An automated mail transporting and sorting apparatus is provided. The automated mail transporting and sorting apparatus includes an identifying and processing machine for determining a particular category from a group of at least two categories of each mail item of a continuous stream of mail items, the at least two categories including a first category and a second category; a first sorting machine for receiving mail items of the first category; a second sorting machine for receiving mail items of the second category; and a continuous gripper line including a plurality of grippers, each gripper being adapted to grip one of the mail items processed by the identifying and processing machine, the gripper line arranged and configured to transport mail items of the first category to the first sorting machine and mail items of the second category to the second sorting machine.

A method of transporting and sorting mail items is also provided. The method includes the steps of gripping a stream of mail items including at least two different categories of mail items with a plurality of grippers mounted on a continuous gripper chain so that during normal operation each mail item is gripped by one of the grippers, the at least two different categories including a first category and a second category; transporting the mail items gripped by the grippers with the continuous gripper chain, the mail items of the first category gripped by the grippers being transported towards a first sorting machine and the mail items of the second category gripped by the grippers being transported towards a second sorting machine; and releasing the mail items from the grippers to the first sorting machine and the second sorting machine, the mail items of the first category being released from the grippers for processing by the first sorting machine and the mail items of the second category being released from the grippers for processing by the second sorting machine.

A gripper apparatus for receiving mail items of at least two categories from an identifying and processing machine and transporting the mail items to at least two mail sorting machines is also provided. The gripper apparatus includes a continuous gripper line including a plurality of grippers, each gripper adapted to grip one mail item of a stream of mail items processed by the identifying and processing machine; and a controller for receiving signals from the identifying and processing machine identifying the category of each mail item and for directing the gripper line to selectively, based on the received signal, release the mail item to a corresponding one of the at least two mail sorting machines.

### BRIEF DESCRIPTION OF THE DRAWINGS

The present invention is described below by reference to the following drawings, in which:

FIG. 1 is a block diagram of an exemplary embodiment of an automated product transporting and sorting system according to the present invention;

FIG. 2 shows a highly schematic view of a more detailed setup of the exemplary embodiment of the automated product transporting and sorting system shown;

FIGS. 3 and 4 show perspective views of basic components of an embodiment of the automated product transporting and sorting system in which no downstream reject station is included;

FIGS. 5 and 6 show a preferred embodiment of grippers mounted on a portion of a gripper chain, which may be employed in gripper lines in embodiments of the automated product transporting and sorting system;

FIG. 7 shows a view of a cross-sectional portion of one preferred embodiment of a gripper track that may be used in embodiments of the automated product transporting and sorting system;

FIG. 8 shows a side view of an embodiment of a drive system interacting with a gripper chain that may be used in embodiments of the automated product transporting and sorting system;

FIG. 9 shows a perspective view of the drive system shown in FIG. 8;

FIG. 10 shows a side view of drive system shown in FIG. 8;

FIG. 11 shows a perspective view of a pneumatic selective release cam preferably used for opening grippers in embodiments of the automated product transporting and sorting system;

FIG. 12 shows a perspective view of the pneumatic selective release shown in FIG. 11 adjacent to a gripper track;

FIG. 13 shows a block diagram of various electrical components of an electrical control system that may be used in embodiments of the automated transporting and sorting system; and

FIG. 14 shows a screenshot of graphical user interface indicating a gripper path and available release points that may be utilized with embodiments of the automated transporting and sorting system.

### DETAILED DESCRIPTION

U.S. Pat. No. 6,671,577, referenced above, mentions pinch belts. Belt systems may be used to transport letters in these kinds of machines.

However, a belt system may be limited in flexibility and transport length. A belt system may be a reliable transport if there is only one letter at a time within a gap in between belts. The velocity of the mail becomes very high at high capacities. Slip between mail and belt may occur during the transport, which may cause jams in the line and consequently limit the productivity of the system. Access to each section of the belt is also generally required to remove possible jams. Overhead sections may require the use of ladders or lifts for clearing jams or maintaining the belt section. A pinch belt system is not a custodial system and letters are tracked by keeping a sequential order from input to output of the belt. A disadvantage of such tracking is that if a letter is lost during transport or cleaning a jam, the tracking information may get mixed up and the letters may be sorted to incorrect locations. Additional sensing and reading devices may then be necessary to correct these sorting mistakes. Also, the complete line may have to be purged before letters may be tracked again or the mistakes may have to be corrected by hand.

In accordance with certain embodiments of the present invention, transporting and sorting mail from several input locations to several output locations is achieved with custodial gripper chains.

The automated product transporting and sorting system connects islands of automation to improve the workflow and eliminate the manual process of moving mail between subsequent operations. The output of each AFCS is connected to at least one DBCS. Each AFCS orients incoming mail for automated processing, cancels postage stamps and scans the front of each piece of mail to determine the ZIP code and delivery point information. Each AFCS then separates the mail for further automated processing based on the determined category of the mail. The DBCSs read barcodes on each piece of mail and sort the mail accordingly for delivery. The system according to this exemplary embodiment may advantageously have a high operating consistency, flexibility of different configurations, modularity, and ease of use at a high rate of velocity. Embodiments of the automated product transporting and sorting system may be implemented into an existing location, for example, a post office or other mail processing center, to work with conventional AFCS and DBCS machines. The AFCS and DBCS machines may be altered as necessary to operate as desired.

The automated product transporting and sorting system includes a delivery product gripper with selective control. With one mail piece in each gripper, the selective control identifies and tracks each mail piece from pick up to the correct destination. The individual grippers and chain may form a continuous link between an AFCS and at least one DBCS, delivering the mail in a continuous real time flow, processed without delay.

A number of options and alternatives are available with this system, for example, the system may be adapted to conform with layouts of existing AFCS and DBCS mailrooms. The system advantageously allows for flexibility and ease of adaptation to various configurations. Additional complexity and integration is also possible.

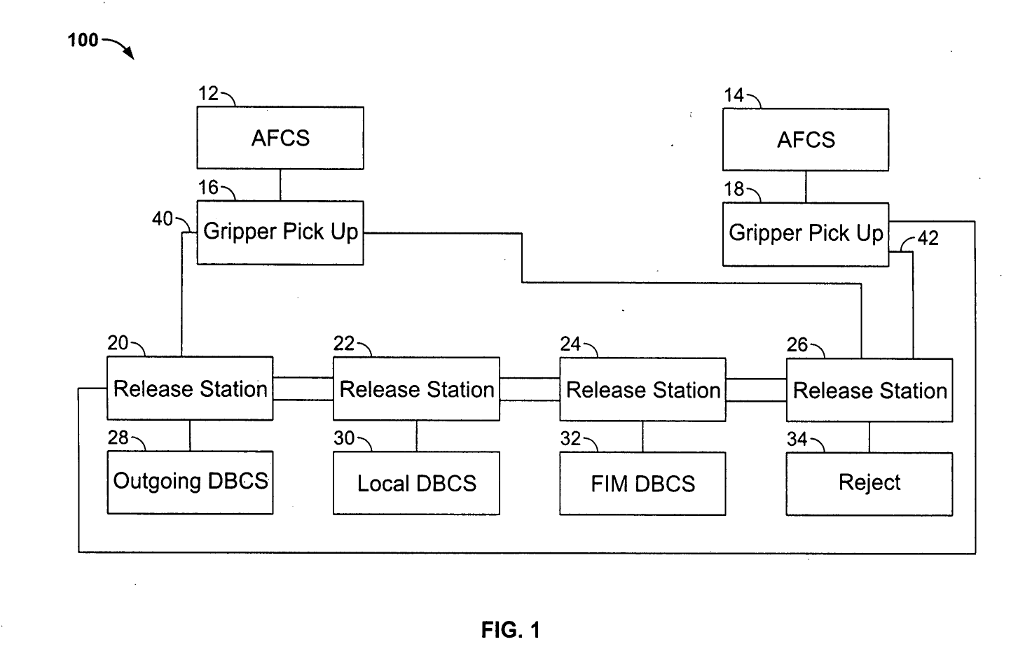

FIG. 1 is a block diagram of an exemplary embodiment of an automated product transporting and sorting system 100 according to the present invention. Mail enters system 100 at AFCSs 12, 14, which each processes the mail and identifies a category, for example, outgoing mail, local mail, mail with Facing Identification Marks (“FIM”), or reject mail, of each piece of mail. The processed mail is then transported from the respective AFCS 12, 14 to a respective gripper pick up station 16, 18. At gripper pick up station 16, a first gripper line 40 grips each mail piece processed by AFCS 12 and positively controls and transports each piece of mail to one of release stations 20, 22, 24, 26 depending on the category identification thereof. At gripper pick up station 18, a second gripper line 42 grips each mail piece processed by AFCS 14 and positively controls and transports each piece of mail to one of release stations 20, 22, 24, 26. All mail identified as outgoing mail is transported to release station 20 to be sorted by DBCS 28, all mail identified as local mail is transported to release station 22 to be sorted by DBCS 30, all mail identified as FIM mail is transported to release station 24 to be sorted by DBCS 32 and all mail identified as reject mail is transported to release station 26 for handling by rejection station 34.

A simple and straightforward approach may be based upon conventional gripper components with established selective release control. Additional system requirements and capabilities may also be employed, for example, the number of categories and release stations and path may be varied as desired.

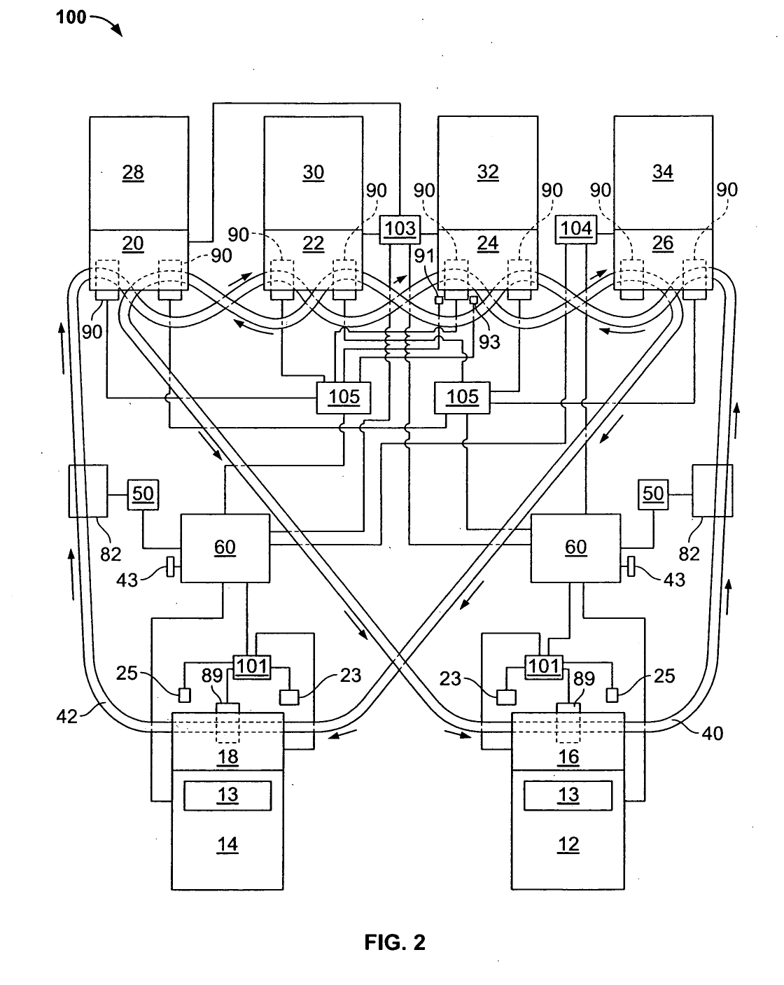

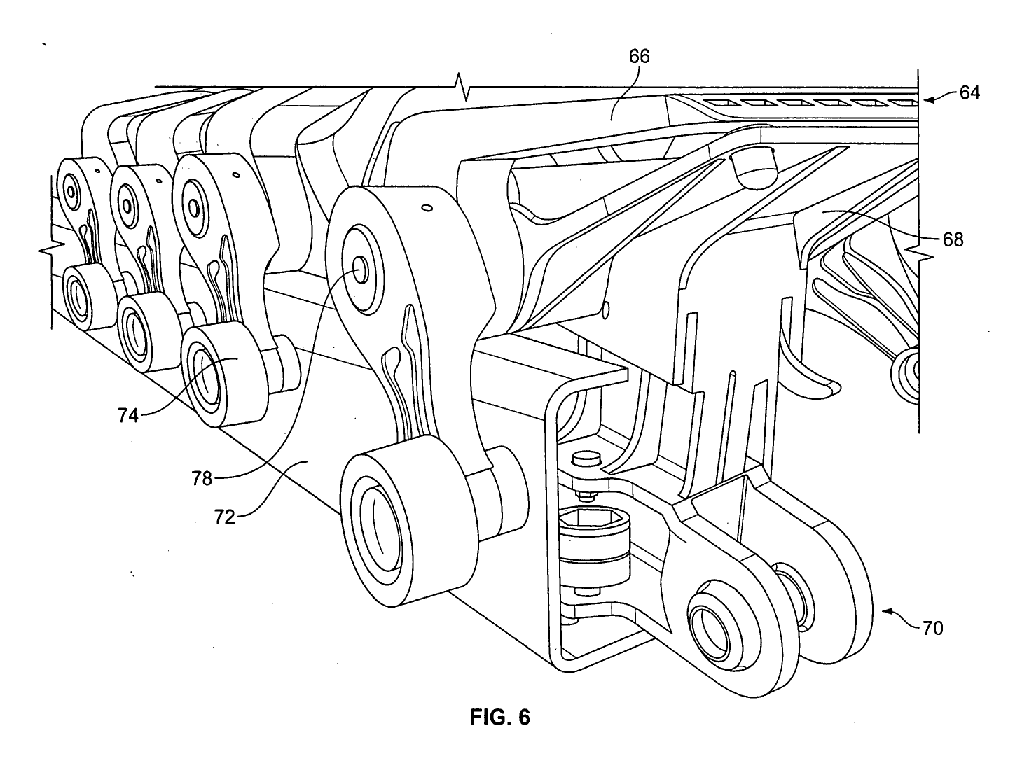

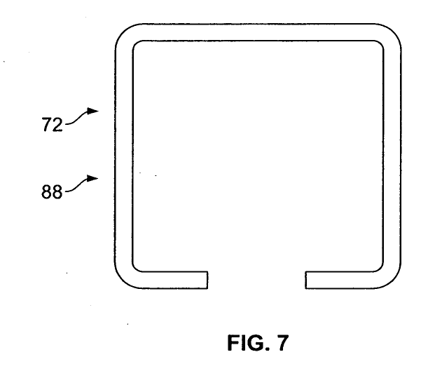

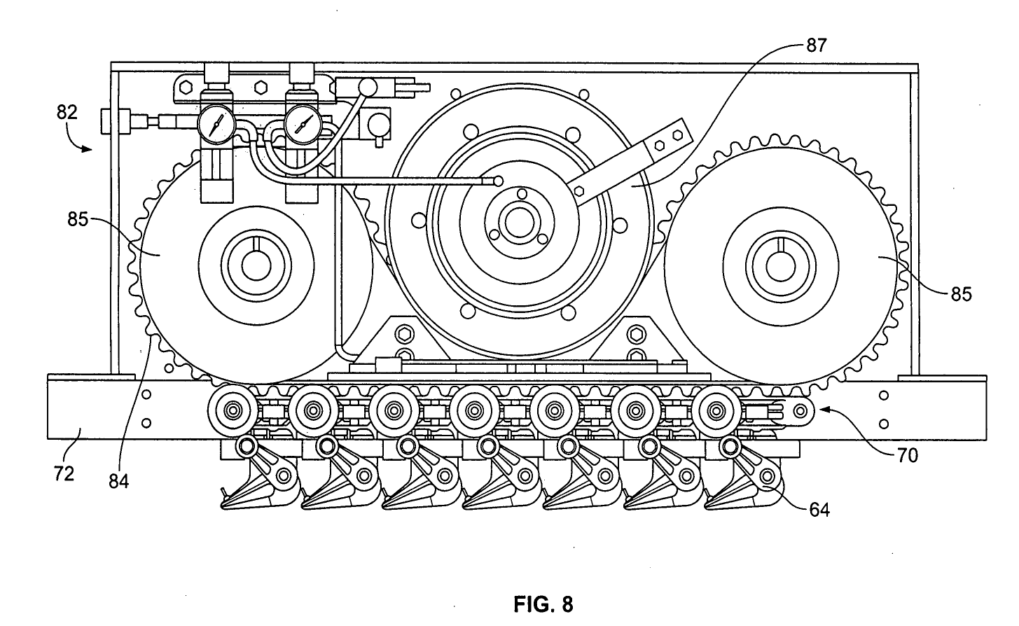

FIG. 2 shows a highly schematic view of a more detailed setup of the exemplary embodiment of automated product transporting and sorting system 100. Each gripper line 40, 42 includes a plurality of grippers mounted on a gripper chain, which is guided by a gripper track. In a preferred embodiment, each gripper line includes grippers 64 (FIGS. 6, 7), a gripper chain 70 (FIGS. 6, 7), and a gripper track 72 (FIGS. 7, 8) which guides gripper chain 70. Each gripper line 40, 42 is driven by a drive system 82, which may be controlled by a gripper line controller 50.

The gripper lines 40, 42 pick up each individual mail piece, for example, first class letters, processed by the respective AFCSs 12, 14, with each such mail piece orientated into the proper postal indicia direction. In a preferred embodiment, the mail pieces are all aligned in the same orientation.

In order to minimize disruption to the operation already existing at a mailroom location and to simplify the pick up by gripper lines 40, 42, letters (mail pieces) processed by each AFCS 12, 14 are each directed to a single transfer point in the respective gripper pick up stations 16, 18, which are attached to AFCS 12, 14, respectively, just past where the conventional AFCS machines include a section 13 that includes a reject station or a reverter operation, where the letters (mail pieces) are acquired by the grippers. this may require only one reverter per AFCS 12, 14. System 100 receives electronic sorting information corresponding to each mail piece from an optical scanner of each AFCS 12, 14. The electronic sorting information supplied by the optical scanners indicates the correct sort release location, i.e., which release station 20, 22, 24, 26 each mail piece is to be release by the corresponding gripper line 40, 42. Utilizing a new AFCS output position past section 13 may minimize the disruption to the production operation and may retain the same capability as currently available. Keeping the existing input/output positions active on each machine is important for maximum throughput.

After each mail piece passes through the corresponding AFCS 12, 14, the mail piece is transferred to and synchronized with the respective gripper line 40, 42. Each mail piece may be transported through an induction conveyor to the gripper pick up location of the corresponding gripper pick up station 16, 18 using a series of tapes and belts very similar to the transportation system used in a conventional AFCS. Each mail piece is then tracked by a custodial control system utilizing precise encoders and sensors. The lead edge of each mail piece is determined and the velocity of each mail piece may be matched to the gating window of the next available gripper of the corresponding gripper line 40, 42. Based upon the location of the lead edge of a mail piece as the mail approaches the pick up location in the corresponding gripper pick up station 16, 18, the velocity of a gripper chain of the corresponding gripper line may also be adjusted (incremented or decremented) automatically to achieve the best match. The velocity synchronization between mail pieces and grippers does not have to match perfectly as each gripper of gripper lines 40, 42 has deep flanges. Mail piece placement within a gripper is more important than an exact velocity match.

Each gripper line 40, 42 that picks up all the mail from a respective AFCS 12, 14, with the help of the respective gripper line controller 50 and a respective overall system controller 60, tracks the position of each piece of mail with selective control, transports each mail piece overhead, and releases each piece of mail at an appropriate DBCS. Mail piece sort data communicated to system controllers 60, combined with an ability to track individual grippers, allows system 100 to deliver the pieces of mail to the exact downstream equipment required. System 100 is modular and easily configurable based upon the different requirements at each mailroom location.

The function of gripper lines 40, 42 is to time the placement of each mail piece from pick up stations 16, 18 into the next available gripper of gripper lines 40, 42. Gripper chains of gripper lines 40, 42 are velocity tracked to each mail piece through the induction conveyor to maximize the mail piece placement within grippers of gripper lines 40, 42. One mail piece will be fed into each gripper. Grippers may be closed by pick up cams 89 at pick up stations 16, 18 to grip mail pieces. This provides positive and custodial control of each mail piece and will result in accurate placement of the mail at the appropriate subsequent operation. With information provided by the optical scanners of AFCSs 12, 14, each individual gripper will be identified electronically and tracked until the mail piece is at an appropriate release destination at one of the release stations 20, 22, 24, 26.

Gripper lines 40, 42 may follow a velocity of an associated AFCS 12, 14, respectively, through an encoder signal, either generated from a rotating shaft or supplied digitally from a drive of the associated AFCS 12, 14. However, products leaving each AFCS 12, 14 may not be consistent in spacing or velocity. A mail supply sensor 23, which in a preferred embodiment is a laser, may be located just prior to each gripper pickup station 16, 18 and may detect leading edges of products. Each mail supply sensor 23 may send signals to the respective gripper line controller 50 via the respective overall system controller 60 to modify the respective gripper drive system 82 accordingly to accelerate or decelerate the respective gripper chain 70 (FIGS. 6, 7), so that one gripper picks up each piece of mail. The velocity of the respective gripper chain 70 may be adjusted to follow the product flow and assure complete product capture. A pick up verification sensor 25 may also be provided to check mail piece placement in a respective gripper. Each pick up cam 89, mail supply sensor 23 and verification sensor 25 may be electrically coupled to a gripper pick up controller 101 that monitors pick up at each pick up station 16, 18 and controls each pick up station 16, 18.

Once a mail piece is contained in a gripper of one of gripper lines 40, 42 the mail piece will be transported to an appropriate release station 20, 22, 24, 26 of the respective DBCS 28, 30, 32 or a reject station 34. There is no harm in an empty gripper being circulated in gripper lines 40, 42. If no mail pieces are being presented to grippers at gripper pick up stations 16, 18, the gripper chain may continue to run out, release all of its mail pieces and then optionally slow or stop after a predetermined time.

The exact sequence that grippers systems 40, 42 release mail to release stations 20, 22, 24, 26 may have no impact on the performance of the gripper lines 40, 42. Each gripper line 40, 42 may supply multiple release locations in any progression. In other words, gripper line 42 transporting mail pieces away from AFCS 14 may be routed to the reject station 34 initially because of the physically proximity, while gripper line 40 transporting mail pieces away from AFCS 12 may be first directed to DBCS 28. DBCS release stations 20, 22, 24 may be controlled by a DBCS release station controller 103 and reject release station 26 may be controlled by a reject release station controller 104. Automated transporting and sorting system 100 may include a number of data elements indicative of operating efficiency. Statistical information on pick up accuracy, missed pickups, drop accuracy, rejects and product counts at each release location may be available. Additional performance information for mailroom management may be incorporated.

At the appropriate release station 20, 22, 24, 26, grippers 64 may be opened by release cams 90 to release each mail piece. Release stations 20, 22, 24, 26 are designed to open an appropriate gripper containing a specific mail piece for the corresponding DBCS 28, 30, 32 or reject station 34 and transport the mail piece into the DBCS 28, 30, 32 for continued sorting or reject station 34 for other operations. Each gripper line 40, 42 has a separate corresponding release location within release stations 20, 22, 24, 26 thus each release station 20, 22, 24, 26 may include two release cams 90, each corresponding to a griper line 40, 42. Verify sensors 91, 93 may be installed to check mail piece placement in the gripper at the release? station, just prior to the release point and then just after the release point to verify the mail piece was successfully released. Accordingly, each release station 20, 22, 24, 26 may include sensors 91, 93 before and after each release cam 90. A gripper release controller 105 electrically coupled to release cams 90 and sensors 91, 93 may be provided for each gripper line 40, 42, for monitoring gripper release of each mail piece. The mail products from each gripper line 40, 42 are merged into a single stream after being released, using belts and product switches similar to the AFCS product transportation mechanism, for presentation to a respective feeder of each DBCS 28, 30, 32 or rejection station 34.

Gripper lines 40, 42 advantageously may not require any daily operator adjustment prior to production. Appropriate communication signals may be available from conventional AFCS and DBCS machines to confirm that the machines are in run mode and ready to receive products. If a piece of downstream equipment is not available and the downstream equipment was desired to operate the system, the operator may need to configure the system release points on a human machine interface (“HMI”), which in a preferred embodiment is a graphic user interface (“GUI”). One HMI may be provided for each gripper line. Once the downstream release points are selected, the gripper velocity, release timing, etc., may all be automatically handled by the gripper line controllers. One overall system controller 60 may be provided for each gripper line 40, 42. Each controller 60 may be in communication with controllers 50, 101, 105 associated with each gripper line 40, 42, the respective AFCS 12, 14 associated with each gripper line and controllers 103, 104 to control operation of system 100.

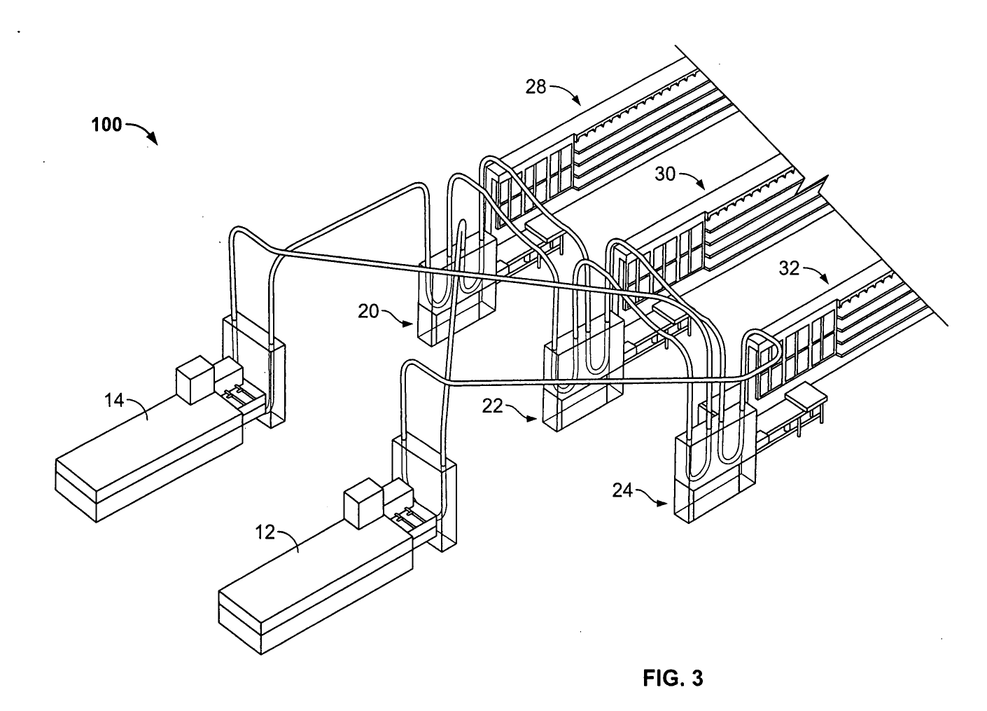

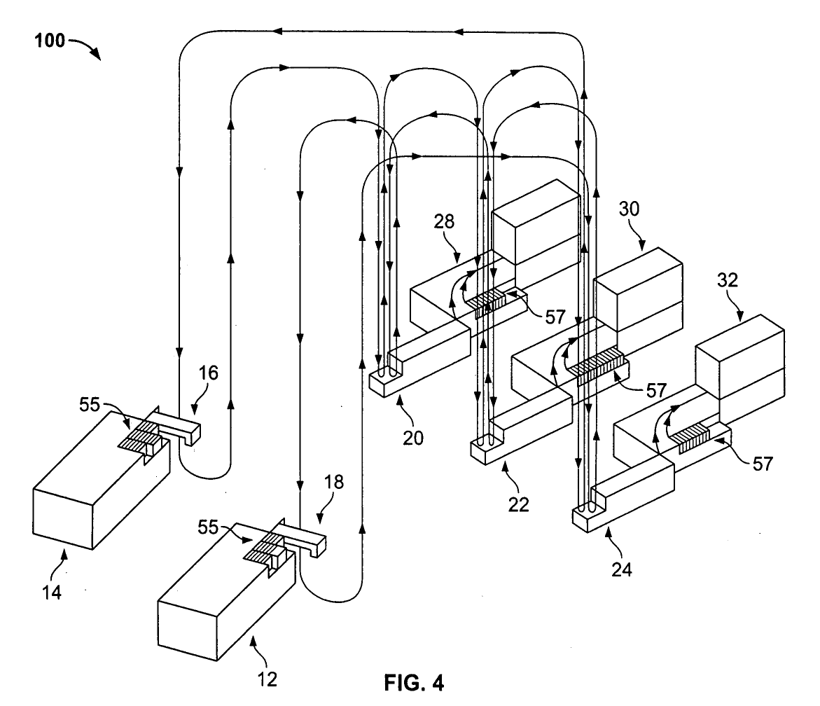

FIGS. 3 and 4 show perspective views of basic components of an embodiment of automated product transporting and sorting system 100 in which no downstream reject station is included. AFCSs 12, 14 process and identify mail pieces, which are passed to respective gripper lines 40, 42 at pick up stations 14, 16. AFCSs 12, 14 are conventional AFCSs that include stackers 55, which may be used for manual unloading when necessary. Grippers lines 40, 42 transport each mail piece to the appropriate DBCS 28, 30, 32 by releasing each mail piece at respective release stations 20, 22, 24. DBCSs 28, 30, 32 are conventional DBCSs that include manual loading stations 57 that may be loaded with mail pieces when necessary.

In other embodiments, the number of AFCSs and DBCSs may be increased or decreased. Preferably, each gripper line picks up mail at one AFCS and releases mail at as many downstream pieces of equipment, such as DBCSs, as necessary. Thus, each AFCS unit has a separate corresponding gripper line. Each DBCS, or other downstream equipment, then has multiple gripper lines supplying mail pieces, and in the end has a higher net processing output than a single transport system. At the release stations of the downstream equipment, the mail pieces from each gripper line may be combined into a single stream for introduction into an in-feed buffer. Additional AFCS units may be added to accommodate changes at a mailroom location.

Picking up at only at a single gripper pick up station 16, 18 for each AFCS 12, 14, respectively, may simplify the product change between components and may reduce the concerns of matching velocities and transitions. The mail stream may be supplied in a continuous stream to the downstream equipment with the highest integrity. The use of the gripper chain may eliminate issues with tracking variable product in belts. Issues such as velocity matching, substrate friction characteristics, and belt tension for products of uneven thickness, especially over longer distances, may be eliminated by positive gripper control.

If one of AFCSs 12, 14 stops, for example AFCS 12, depending upon the nature of the disruption and the intelligence available, gripper line 40 may continue to distribute mail pieces or may stop. AFCS 14 may continue to run and gripper line 42 may continue to deliver mail pieces to a corresponding DBCS 28, 30, 32, realizing a continuing high throughput.

If one of DBCSs 28, 30, 32 stops, for example DBCS 28, gripper lines 40, 42 may continue to operate and release mail pieces at DBCS 28 until an input buffer of DBCS 28 is full. After the input buffer of DBCS 28 is full, gripper lines 40, 42 may stop or continue to run and release mail pieces intended for DBCS 28 to an alternate release location. The non-standard operating conditions may be determined by monitoring the buffer capacity of DBCS 28. As an in-feed station of DBCS 28 fills, gripper lines 40, 42 may react differently. If DBCS 28, for example, stops, and AFCSs 12, 14 are conventional AFCSs that include stackers 55, mail may also be diverted to the stackers 55 because of the arrangement of gripper pick up stations 16, 18 with respect to AFCSs 12, 14, respectively.

As an example, if DBCS 32, which processes the FIM mail, stops, AFCSs 12, 14 may continue to operate and route mail to gripper pickup stations 16, 18, respectively, and only the FIM mail would be diverted to the AFCS existing manual FIM locations in stackers 55 on AFCSs 12, 14. Each of the DBCS 28, 30, 32 are not tied to any specific AFCS 12, 14 but will receive sorted mail from all operating AFCSs. If additional flexibility is desired, three overflow release locations, one for each type of mail—outgoing mail, local mail, and FIM mail—may be added to automated transporting and sorting system 100.

In another embodiment, if two DBCS are processing the same type of mail, as an example, two DBCS machines are processing outgoing mail, and one stops, then the gripper lines may be configured to automatically change from batch mode (alternating delivery of ten pieces to each DBCS for example) to a mode in which all outgoing mail pieces are delivered to the operating DBCS. If an in-feed of one of the two DBCSs processing outgoing mail starts to fill up because the DBCS encountered several thick pieces of mail, the gripper lines could react to even the flow between the two DBCS machines. Alternately, rather than splitting the load of outgoing mail evenly between two DBCSs, a lead/lag relationship may be set up between the two DBCSs where the first DBCS takes the majority of the outgoing mail pieces and the second DBCS just gets overflow.

In embodiments where the existing stackers 55 are retained on the AFCSs of the mailroom location in which an automated transporting and sorting system according to the present invention are employed, advantageously a momentary buffer is provided if all the AFCSs happen to run at the same type of mail temporarily overloading the DBCS capacity. Additionally, if the DBCS input buffer becomes close to full, the system may automatically reduce the velocity of the operating AFCSs or inhibit feeding by the AFCSs until the surge is reduced.

Additionally, mail pieces rejected at the AFCSs, for example, doubles, unreadable pieces, etc., may be directed into the respective gripper line and may be subsequently released at a centralized reject location, for example, rejection 34 via release station 26 shown in FIGS. 1 and 2. A potential benefit is that all the reject mail pieces from all the AFCS units may automatically be dropped in one location for further processing without manual transportation. An alternative option is to leave the rejected pieces at each AFCS, for example, in stackers 55. Also, additional release location points may be incorporated as desired to provide a temporary buffer location to collect any overflow.

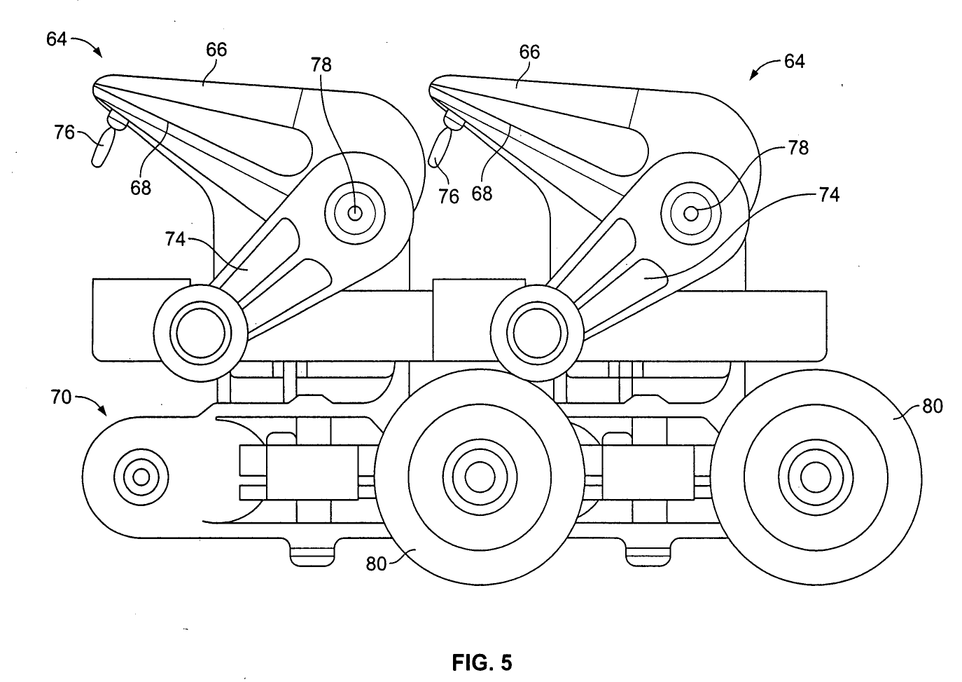

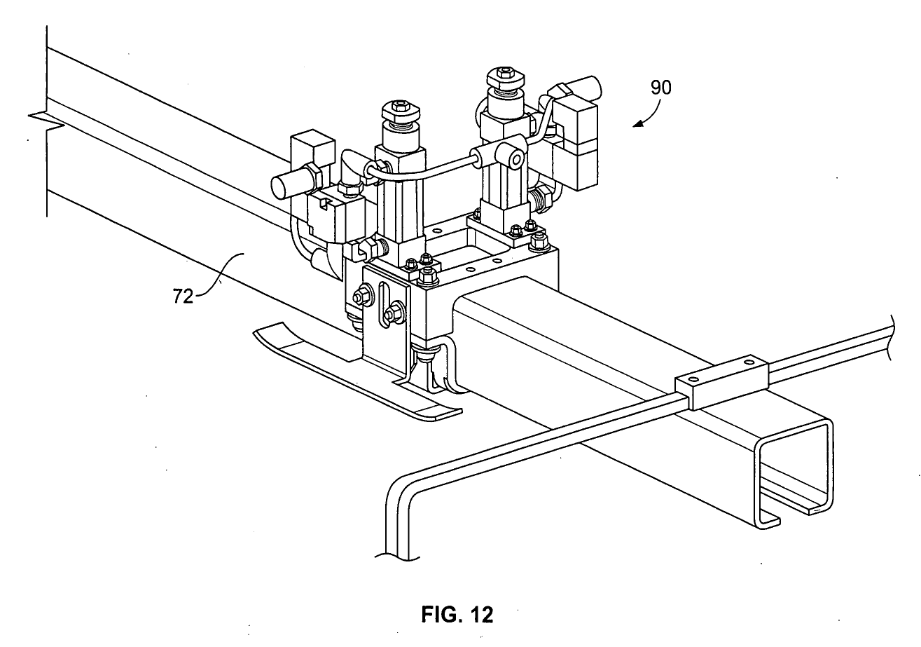

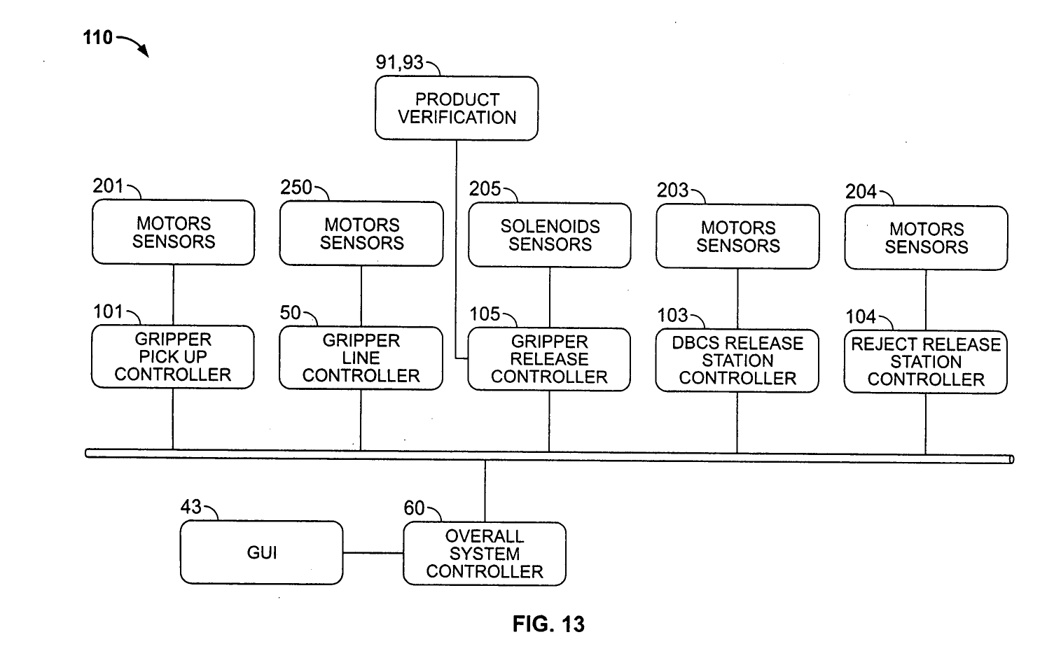

FIGS. 5 and 6 show a preferred embodiment of grippers 64 mounted on a portion of a gripper chain 70, which may be employed in gripper lines 40, 42 (FIGS. 1 to 4). FIG. 6 shows a portion of gripper chain 70 inside of a gripper track 72. In a preferred embodiment, gripper chain 70 is plastic and gripper track 72 is an alloy steel. Grippers 64 each include two spring loaded flanges 66, 68 that function much like a clam shell. Grippers 64 are spring loaded so the flanges are closed(?). Each gripper 64 may be latched and released by an interaction of a gripper arm 74 with selectable, movable cams mounted on track 72. Grippers 64 may be latched closed by a force of a pick up cam 89 (FIG. 2) against gripper arms 74 and opened by a force of release cam 90 (FIGS. 12, 13) actuating a release latch 76 located at the bottom of each gripper 64. Due to the spring load, grippers 64 may handle variable product thicknesses without requiring any adjustment. For example, grippers 64 may routinely handle products ranging from a single sheet to products more than ⅜″ thick. Grippers 64 may release a product selectively at release stations 20, 22, 24, 26 (FIG. 1) based upon gripper tracking information.

Grippers 64 are attached to and transported by composite chain 70. Each gripper 64 may be mounted to a link of chain 70 by a single screw fastener 78 allowing for quick and easy removal. In a preferred embodiment, gripper chain 70 is based upon a 3.5″ pitch and may articulate in two directions. Each link of gripper chain 70 includes a drive cog 80 that engages with a timing drive belt 84 (FIGS. 8 to 10) at a gripper drive system 82 (FIGS. 8 to 10).

Currently grippers 64 are used extensively in the printing and newspaper industries to transport and track magazines, catalogs and newspapers between various operations at velocities up to 80,000 products per hour. The shortest systems are about 200′ and the longest are over 1800′ long. In some applications, grippers 64 are used to transport products between buildings in a walkway over the street.

Goss International Americas, Inc. manufactures several different types of grippers based upon the product size, weight, and velocity of product being conveyed. Grippers 64 may be customized based on specific requirements of grippers systems 40, 42.

FIG. 7 shows a view of a cross-sectional portion 88 of one preferred embodiment of gripper track 72. Cross-sectional portion 88 is tubular, versatile and easy to configure for specific routings. Gripper track 72 may be modular and may include straight sections, curves and twists. Gripper track 72 may be configured with horizontal or vertical curves in any angle of 180 degrees or less as well as compounded curves. Gripper track 72 may also be easily cut and welded to make any configuration necessary. This flexibility in track layout and design may advantageously resolve a number of field location problems. While the most direct route between pick up and release points is generally preferred, frequently air handling ductwork, lighting, and other utilities may prevent the most direct route from being possible. Gripper track 72 may be easily configured and rerouted to avoid any obstacle. Gripper track 72 also may be modified during the installation to avoid any obstructions and gripper track 72 and gripper chain 70 may be routed vertically between floors if necessary. In addition, gripper track 72 may be altered at a later date if equipment or layout changes are necessary.

Gripper track 72 may be floor supported or suspended from the ceiling as determined by the facility requirements. An advantage of a ceiling supported system may be the elimination of any floor obstacles.

FIG. 8 shows a side view of drive system 82 interacting with gripper chain 70. Grippers 64 are mounted on a portion of gripper chain 70, which is supported by a portion of gripper track 72. Drive system 82 uses a tooth belt 84 meshing with the cogs 80 on the top of gripper chain 70 to drive gripper chain 70. Tooth belt 84 is driven by gears 85 and gear 87. Tooth belt 84 travels in a path around gears 85.

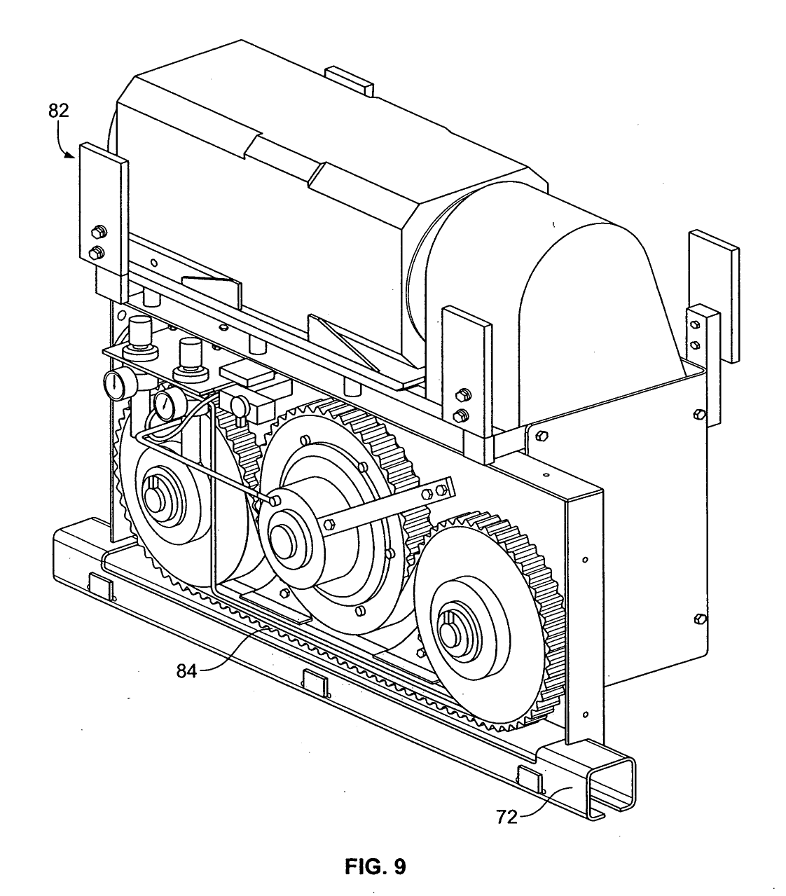

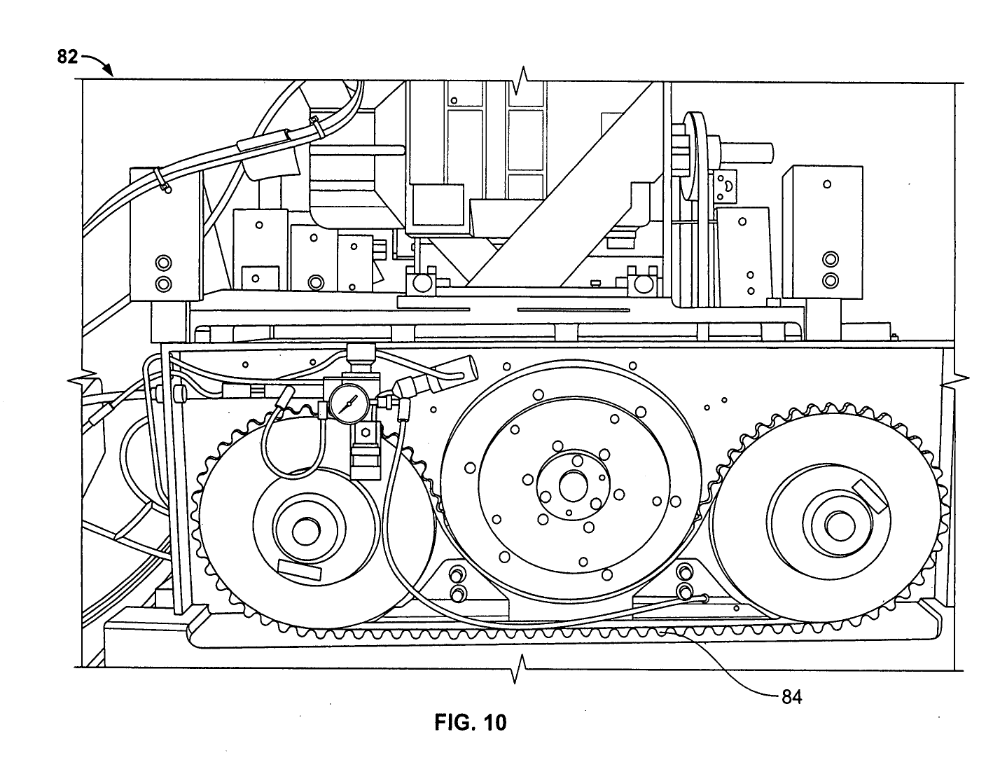

FIG. 9 shows a perspective view of drive system 82 and FIG. 10 shows a side view of drive system 82. Gripper lines may have as many drive systems as necessary depending upon the distance and weight being carried. Drive system 82 is designed for high velocity operations and is currently used to transport up to 80,000 products per hour depending upon the configuration.

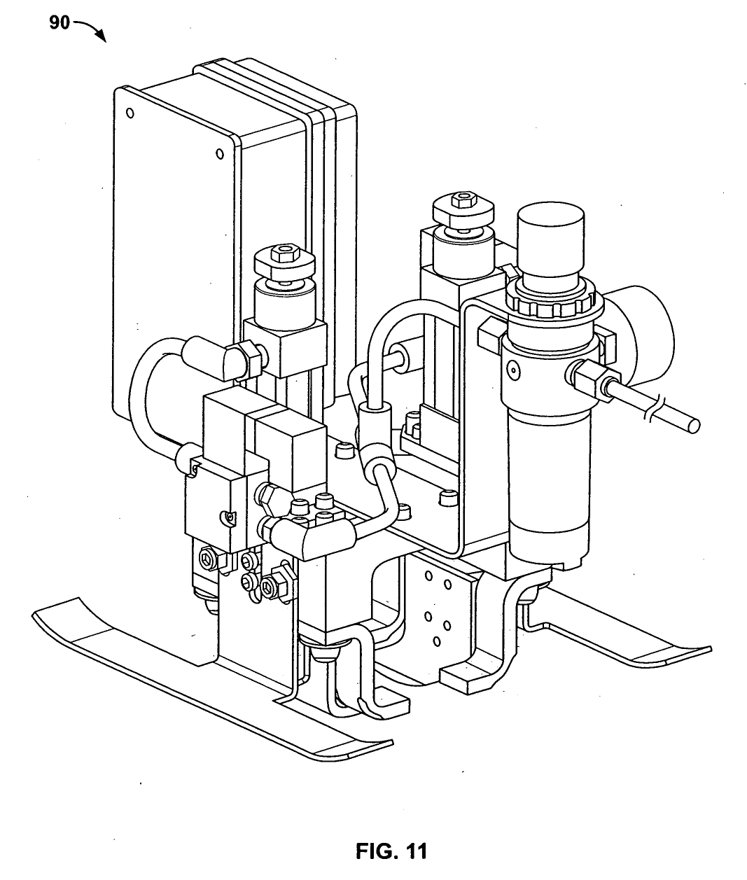

FIG. 11 shows a perspective view of a pneumatic selective release cam 90 preferably used for opening grippers 64 (FIG. 5, 6). FIG. 12 shows a perspective view of pneumatic selective release cam 90 adjacent to gripper track 72. Selective release cam 90 operates to actuate gripper release latch 76 (FIG. 5) at an appropriate time to release the desired products, taking into account a velocity of grippers 64 (FIGS. 5, 6). As gripper chain 70 (FIGS. 7, 8) passes selective release cam 90 and the respective gripper 64 passing release cam 90 includes a mail item in the particular category sorted by the respective DBCS, selective release cam 90 selectively actuates, based on signals sent from the respective overall system controller 60, and trips gripper latch 76 (FIG. 5) located in the center of the respective gripper 64 (FIG. 5), releasing an internal latch within gripper 64 and gripper 64 springs open releasing the mail product.

FIG. 13 shows a block diagram of various electrical components of an electrical control system 110 that may be used in automated transporting and sorting system 100 (FIGS. 1 to 4). Electrical control system 110 has several levels, each level having certain responsibilities. A first level for automated transporting and sorting system 100 is a machine control level. The basic motion, start, stop, velocity tracking is handled at this level. Another level is the products tracking utilizing verify sensors to check product location.

Application specific components control various operations of system 100. Motors and sensors 201 may be employed to manage the gripping of mail pieces and to interact with pick up controller 101 for precise control at pick up stations 16, 18 (FIG. 2). In a preferred embodiment, motors and sensors 201 include sensors 23, 25 (FIG. 2). Motors and sensors 250 may be employed to manage the operation of gripper lines 40, 42 and drive systems 82 and to interact with gripper line controller 50 for precise control of gripper lines 40, 42 (FIG. 2). Solenoids and sensors 205 may be employed to manage the release of mail pieces and to interact with gripper release controller 105 for precise control at release cams 90 (FIG. 2). In a preferred embodiment, product verification sensors 91, 93 also interact with gripper release controller 105 (FIG. 2) to ensure mail items are properly released at the respective DBCS. Motors and sensors 203 may be employed to manage the operation of release stations 20, 22, 24 and to interact DBCS release station controller 103 for precise control of release stations 20, 22, 24 (FIG. 2). Motors and sensors 204 may be employed to manage the operation of release station 26 and to interact with reject release station controller 104 for precise control of release station 26 (FIG. 2). All of the application specific components may be networked to overall system controller 60 (FIG. 2) which has a HMI, preferably GUI 43. Additional information that is available about the mail piece and which may be passed by the mailroom to assist with routing may determine the strength of the network if desired.

Selective control or mail piece tracking is accomplished by associating a specific product and its drop point information with a unique gripper 64 (FIGS. 5, 6) on gripper chain 70 (FIGS. 5, 6). Gripper location is known at all times by sensors and encoders with verification through positive drive system 82 (FIGS. 8 to 10). The basic product tracking information includes the type of mail—local mail, outgoing mail, FIM mail, or reject mail—of each piece of mail and the corresponding release location of each piece of mail.

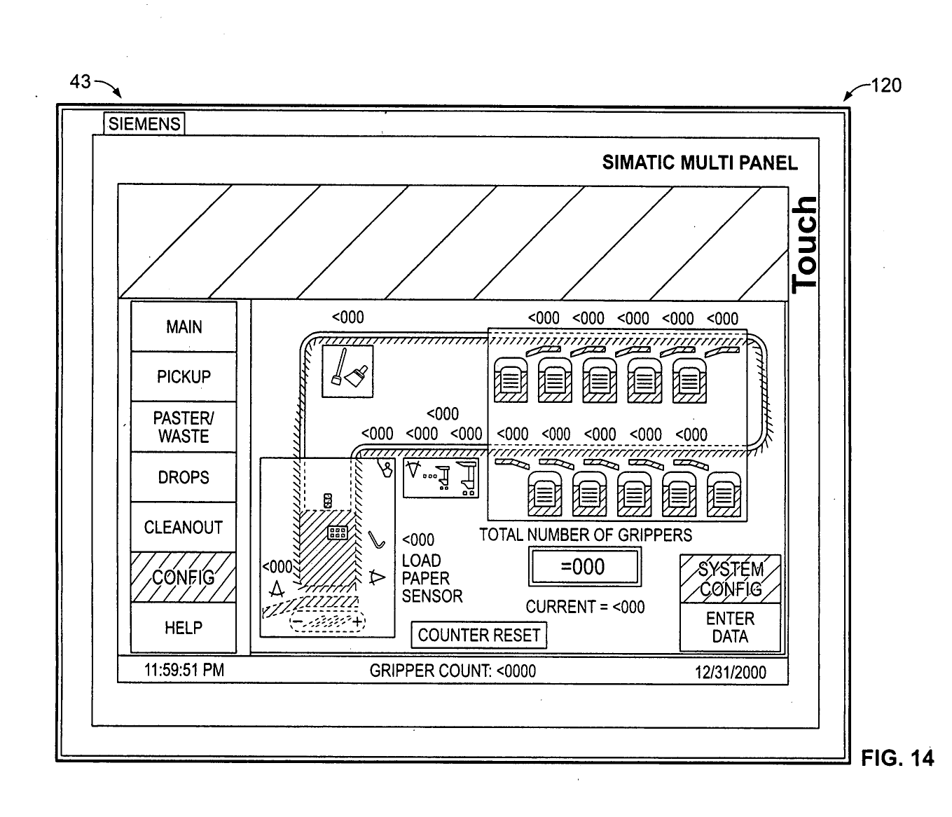

FIG. 14 shows a screenshot 120 of GUI 43 (FIG. 2) indicating the gripper path and available release points that may be utilized with embodiments of the present invention. GUI 43 may utilize a touch screen that has a visual representation of the automated transporting and sorting system, which may allow an operator to easily select desired active path release points and other system configurations. There may be one GUI 43 for each gripper line or AFCS. GUIs 43 may also provide fault enunciation and trouble shooting diagnostics.

Tracking each individual unique mail piece may also be important for successful operation of embodiments of the automated transporting and sorting system. The system may track mail piecesin each gripper and dispose of or correct misfeeds by rerouting the mail piece to the proper release station.

In an alternative embodiment, the proposed gripper lines may be capable of holding up to at least a ⅜″ mail piece. After an AFCS sorts the mail stream an associated gripper line would pick up a variable thickness of mail piece and deliver it to an appropriate DBCS. This may result in a very slow gripper velocity and may introduce a more complicated gripper pick up station at each mail type stacker.

Another possible implementation is another selective delivery approach. Once a mail item is in the gripper at the output of the AFCS and its unique characteristics are known, e.g., the zip code, the item may be transported and released at any number of locations based on the unique characteristic. The gripper could release the mail piece directly to the sorted boxes of the DBCS and bypass the DBCS re-feed and scanning operation completely.

In another embodiment, the address and ink jet coding on each mail piece may be scanned after each mail piece is fed by the AFCS to the respective gripper line. Thus, the mail pieces may be scanned in the custodial control of the gripper and then released at the appropriate sorting boxes of the DBCS. This may allow the vertical space above the floor to be used to process the mail and floor space may be opened up for other equipment.

As outlined above, the system may include the following features:
using custodial gripper for transport and tracking letter information—the distance from gripper to gripper is much smaller than the distance between mail items in a conventional belt system, therefore the transport velocity may be greatly reduced;
one gripper line for each AFCS or any canceling device may go to as many DBCS or barcode reader and sorting system as required;
each AFCS unit may have a synchronization/buffer device to align and feed the letters in the grippers;
current stackers may stay in AFCS and DBCS machine to allow for continuous production manually if any DBCS goes down;
additional drops for stackers may be added to the gripper line to allow for continuous production if any DBCS goes down;
each DBCS may have a release station for each gripper line from the connected AFCSs;
DBCS release stations may be merged into a buffer section at each DBCS to allow for surges in the different mail types;
information about the kind of mail from the AFCS will be used and the letter will be tracked through the system and dropped at the appropriate DBCS system; and
if more than one DSCS for a kind of mail is connected to the AFCS a load sharing algorithm may make sure both machines are kept running constantly.

Further, several AFCS systems may be connected with one gripper line with multiple pick up stations. Also, instead of gripping one mail item at a time, a slug of mail items may be transported together with a single gripper.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An automated mail transporting and sorting apparatus comprising:
an identifying and processing machine for determining a particular category from a group of at least two categories of each mail item of a continuous stream of mail items, the at least two categories including a first category and a second category;
a first sorting machine for receiving mail items of the first category;
a second sorting machine for receiving mail items of the second category; and
a continuous gripper line including a plurality of grippers, each gripper being adapted to grip one of the mail items processed by the identifying and processing machine, the gripper line arranged and configured to transport mail items of the first category to the first sorting machine and mail items of the second category to the second sorting machine.

2. The automated mail transporting and sorting apparatus recited in claim 1 wherein the identifying and processing machine is an advanced facer and canceller system.

3. The automated mail transporting and sorting apparatus recited in claim 1 further comprising a controller for receiving signals from the identifying and processing machine identifying the category of each mail item and for directing the gripper line to selectively, based on the received signal, release the mail item to the first or second sorting machine.

4. The automated mail transporting and sorting apparatus recited in claim 1 further comprising:
a second identifying and processing machine determining which of the at least two categories each piece of mail of a second continuous stream of mail item belongs; and
a second continuous gripper line including a plurality of second grippers, the second gripper line being arranged and configured so that each second gripper is capable of gripping a mail item processed by the second identifying and processing machine, the second gripper line being arranged and configured to transport mail items of the first category to the first sorting machine and mail items of the second category to the second sorting machine.

5. The automated mail transporting and sorting apparatus recited in claim 4 further comprising:
a first controller for receiving signals from the identifying and processing machine identifying the category of each mail item of the continuous stream and for directing the gripper line to selectively, based on the received signal, release the mail item to the first or second sorting machine; and
a second controller for receiving signals from the second identifying and processing machine identifying the category of each mail item of the second continuous stream and for directing the second gripper line to selectively, based on the received signal, release the mail item to the first or second sorting machine.

6. The automated mail transporting and sorting apparatus recited in claim 4 further comprising:
a first mail release station arranged and configured to receive mail items of the first category from the gripper line and the second gripper line and to transport the mail items of the first category to the first sorting machine; and
a second mail release station arranged and configured to receive mail items of the second category from the gripper line and the second gripper line and to transport the mail items of the second category to the second sorting machine.

7. The automated mail transporting and sorting apparatus recited in claim 4 wherein the gripper line releases mail items of the first category to the first mail release station at a first station first release location and releases mail items of the second category to the second mail release station at a second station first release location and the second gripper line releases mail of the first category to the first mail release station at a first station second release location and releases mail of the second category to the second mail release station at a second station second release location.

8. The automated mail transporting and sorting apparatus recited in claim 4 further comprising:
a third sorting machine for receiving mail items, the at least two categories of mail items including a third category of mail, the gripper line and the second gripper lines being arranged and configured to transport mail items of the third category to the third sorting machine.

9. The automated mail transporting and sorting apparatus recited in claim 8 wherein the first category of mail items is outgoing mail items, the second category of mail items is local mail items and the third category of mail items is mail items with mail facing identification marks.

10. The automated mail transporting and sorting apparatus recited in claim 8 wherein the identifying and processing machine and the second identifying and processing machine are automated facer and canceler systems and the first sorting machine, the second sorting machine and the third sorting machine are delivery bar code sorters.

11. The automated mail transporting and sorting apparatus recited in claim 1 further comprising a mail pick up station downstream of the identifying and processing machine, the mail pick up station transporting mail items from the identifying and processing machine to the gripper line.

12. The automated mail transporting and sorting apparatus recited in claim 9 further comprising a rejection station located downstream of the mail pick up station, the at least two categories including a reject mail items category, the gripper line being arranged and configured to transport mail items of the reject mail items category to the reject station.

13. A method of transporting and sorting mail items comprising the steps of:
gripping a stream of mail items including at least two different categories of mail items with a plurality of grippers mounted on a continuous gripper chain so that during normal operation each mail item is gripped by one of the grippers, the at least two different categories including a first category and a second category;
transporting the mail items gripped by the grippers with the continuous gripper chain, the mail items of the first category gripped by the grippers being transported towards a first sorting machine and the mail items of the second category gripped by the grippers being transported towards a second sorting machine; and
releasing the mail items from the grippers to the first sorting machine and the second sorting machine, the mail items of the first category being released from the grippers for processing by the first sorting machine and the mail items of the second category being released from the grippers for processing by the second sorting machine.

14. The method recited in claim 13 further comprising the step of:
gripping a second stream of mail items including the at least two different categories of mail items with a plurality of second grippers mounted on a second continuous gripper chain so during normal operation each mail item is gripped by one of the second grippers, the at least two different categories including a first category and a second category;
transporting the mail items gripped by the second grippers with the second continuous gripper chain, the mail items of the first category gripped by the second grippers being transported towards a first sorting machine and the mail items of the second category gripped by the second grippers being transported towards a second sorting machine; and
releasing the mail items from the second grippers to the first sorting machine and the second sorting machine, the mail items of the first category being released from the second grippers for processing by the first sorting machine and the mail items of the second category being released from the second grippers for processing by the second sorting machine.

15. The method recited in claim 14 further comprising the steps of:
identifying which of the at least two different categories each mail item of the stream of mail items belongs before the mail items are gripped by the grippers; and
identifying which of the at least two different categories each mail item of the second stream of mail items belongs before the mail items are gripped by the second grippers.

16. The method recited in claim 14 wherein the at least two categories of mail items includes a third category of mail items, and the method further comprises the steps of:
transporting the mail items of the third category gripped by the grippers towards a third sorting machine with the continuous gripper chain and releasing the mail items of the third category from the grippers for processing by the third sorting machine; and
transporting the mail items of the third category gripped by the second grippers towards the third sorting machine with the second continuous gripper chain and releasing the mail items of the third category from the second grippers for processing by the third sorting machine.

17. The method recited in claim 16 further comprising the steps of:
sorting the mail items of the first category with the first sorting machine;
sorting the mail times of the second category with the second sorting machine; and
sorting the mail items of the third category with the third sorting machine.

18. The method as recited in claim 16 wherein the first category of mail items is outgoing mail items, the second category of mail items is local mail items and the third category of mail items is mail items with mail facing identification marks.

19. A gripper apparatus for receiving mail items of at least two categories from an identifying and processing machine and transporting the mail items to at least two mail sorting machines comprising:
a continuous gripper line including a plurality of grippers, each gripper adapted to grip one mail item of a stream of mail items processed by the identifying and processing machine;
a controller for receiving signals from the identifying and processing machine identifying the category of each mail item and for directing the gripper line to selectively, based on the received signal, release the mail item to a corresponding one of the at least two mail sorting machines.

20. The gripper apparatus recited in claim 19 wherein the identifying and processing machine is an advanced facer and canceller system.

21. The gripper apparatus recited in claim 19 further comprising pick up station providing mail items of the at least two categories of mail to the gripper line.

22. The gripper apparatus recited in claim 21 further comprising a pick up cam arranged and configured at the pick up station to open each gripper to allow each gripper to grip one mail item of the stream of mail items at the pick up station.

23. The gripper apparatus recited in claim 21 further comprising a pick up verification sensor arranged and configured to determine whether mail items are properly gripped by the grippers at the pick up station.

24. The gripper apparatus recited in claim 21 further comprising a mail supply sensor arranged and configured to detect leading edges of mail piece before the mail pieces are gripped by the grippers at the pick up station and to communicate the detection of the leading edges to the controller, the controller capable of accelerating or decelerating the gripper line based on the detection of the leading edges so that each mail piece is properly gripped by a respective gripper.

25. The gripper apparatus recited in claim 19 further comprising a first release station adapted to receive mail items of the first category from the gripper line and a second release station adapted to receive mail items of the second category from the gripper line.

26. The gripper apparatus recited in claim 25 further comprising a first release cam adapted to cause grippers transporting mail items of the first category to the release the mail items of the first category at the first release station and a second release cam adapted to cause grippers transporting mail items of the second category to release the mail items of the second category at the second release station.

27. The gripper apparatus recited in claim 25 further comprising a first station release verification sensor adapted to determine whether the mail items of the first category are properly released by the grippers at the first release station and a second station release verification sensor adapted to determine whether the mail items of the second category are properly released by the grippers at the second release station.
